(19) United States
(12) Patent Application Publication
(10) Pub. No.: US 2021/0352902 A1
(43) Pub. Date: Nov. 18, 2021

(54) COMPOSITION FOR GROWTH STIMULATION AND RESISTANCE TO STRESS FACTORS FOR PLANTS OF THE CANNABACEAE FAMILY

(71) Applicant: PSIMOS, INC., New Canaan, CT (US)

(72) Inventors: Aleksei Valentinovich KRAMARENKO, Cheboksary (RU); Dmitry Mikhaylovich MIKHAYLOV, Moscow (RU); Alexey Sergeevich PRONICHKIN, Dimitrovgrad (RU)

(21) Appl. No.: 17/320,757

(22) Filed: May 14, 2021

Related U.S. Application Data
(60) Provisional application No. 63/025,390, filed on May 15, 2020.

(51) Int. Cl. A01N 55/02; A01N 37/36; A01N 37/44; A01N 37/42; A01N 37/46; A01N 25/02; A01N 37/02; A01N 43/40; A01N 43/78; C05D 1/00

(52) U.S. Cl. CPC A01N 55/02; A01N 37/36; A01N 37/44; A01N 37/42; C05D 1/00; A01N 25/02; A01N 37/02; A01N 43/40; A01N 43/78; A01N 37/46

(57) ABSTRACT

According to some embodiments, a composition for stimulating the growth of phytomass and plant resistance to stress factors, containing a water-soluble composition is provided, the composition comprising: at least one amino acids; solvent compound; vitamin b in the amount of 0.01% to 1.1% by volume of the total composition; citrate, in an amount from 0.05% to 2.5% by volume of the total composition; pyruvate in an amount from 0.2% to 2.8% by volume of the total composition; malate in an amount from 0.1% to 3.5% by volume of the total composition; at least one trace element; and at least one carboxylic acid; wherein the composition is water-soluble and wherein the pH of the composition is from 5.0 to 10.3. Numerous other aspects are provided.

### CROSS REFERENCE TO RELATED APPLICATION

The present application claims priority from the following U.S. Provisional Patent Application, which is hereby incorporated by reference herein in its entirety for all purposes: U.S. Provisional Patent Application Ser. No. 63/025,390, filed May 15, 2021, and entitled “COMPOSITION FOR GROWTH STIMULATION AND RESISTANCE TO STRESS FACTORS FOR PLANTS OF THE CANNABACEAE FAMILY” (Attorney Docket No. P18.001P)

### FIELD OF THE INVENTION

The invention generally pertains to compounds for stimulating phytomass growth and resistance to stress factors in plants of the family Cannabaceae. More particularly, the invention relates to amino acid compositions.

### BACKGROUND

Higher plants cultivated in agriculture are complex autotrophic organisms that synthesize organic substances from mineral substances together with microorganisms bound in the soil. It is desirable to obtain the highest productivity from the plant. Compositions may be used to encourage plant productivity. However, conventional compositions may have particle sizes that are too large to be absorbed by soil biota and plants. Conventional compositions may also have unbalanced proportions of substances in their compositions, resulting in limited utility and effectiveness.

It would be desirable to provide a composition to improve the productivity of plants.

### SUMMARY

In one or more embodiments, a composition for stimulating the growth of phytomass and plant resistance to stress factors is provided. The composition contains a water-soluble composition including at least one amino acid; solvent compound; vitamin b in the amount of 0.01% to 1.1% by volume of the total composition; citrate, in an amount from 0.05% to 2.5% by volume of the total composition; pyruvate in an amount from 0.2% to 2.8% by volume of the total composition; malate in an amount from 0.1% to 3.5% by volume of the total composition; at least one trace element; and at least one carboxylic acid. The composition is water-soluble and wherein the pH of the composition is from 5.0 to 10.3.

A technical effect of some embodiments of the invention is an improved fertilizer composition for stimulating the grown of phytomass for plants generally, and, in particular, plants of the family Cannabaceae family, and their individual species and genotypes. As used herein, the terms “fertilizer”, “composition”, and “fertilizer composition” may be used interchangeably. The composition may, in one or more embodiments, increase the quality of plants, and in particular, the fruiting quality of the plants. In one or more embodiments, the composition provides plants with a resistance to stress factors caused by biotic and abiotic stress, including an immunomodulatory effect, as well as a resistance to strains of bacteria. Non-exhaustive examples of stress factors include cold, drought, and fungal disease. Some embodiments may reduce the toxic effect of herbicides on the plant, to allow the plant to exit a “herbicidal pit”. As used herein, “herbicidal pit” may refer to the depressed state of the plant and the slowing down of life processes for several days, due to herbicide stress.

Some embodiments provide a composition including: water-soluble compounds, such as amino acids, or combinations of amino acids; b vitamins, iron citrate, or citric acid; an acidity regulator (e.g., sodium pyruvate or potassium pyruvate, potassium malate, ammonium malate); at least one chelate, trace element, and carboxylic acid; and a solvent compound by volume of the total composition. In one or more embodiments, the pH of the composition is from 5.0 to 10.3.

One or more embodiments provide a composition that may stimulate the growth of phytomass and increase the resistance of the plant to stress factors with efficiency and speed due to the good penetrating ability and high rate of absorption of the composition by the plant. The good penetrability and high rate or absorption may be a result of the ultra-small size of the active substances of the composition. The structure of the composition may be a heterocyclic system including amino acids and chelated compounds in the form of an organometallic group having a branched structure of pyruvates, malates, free amino acids, vitamins, citrates, carboxylic acids and alcohols. Each substance of the composition is necessary for the purposes of this invention and has the property of a whole, forming a single system with new characteristic synergistic properties. It is noted that there may be deletions and minor changes to the composition. For example, humic acid or another suitable substance may act as a carrier of several substances.

Some embodiments provide for a composition that resolves problems affecting the instability of growth and formation of plants. The composition provided by some embodiments may provide for the realization of genetic potential for growth and development to meet objectives of intensive growth of plants, especially in an initial period, and with the use of Photosynthetically Active Radiation (PAR) to more efficiently increase the absorption of the composition by the leaves of the plant.

In one or more embodiments, the composition may be dissolved. Then the dissolved composition may be included on the leaves of a plant, the root system of plants and in the soil to condition the soil, and may act as a stimulant of growth processes on a whole biomass of the plant, activating the metabolism thereof. As used herein, “Biomasss” may refer to the aboveground and underground parts of a plant. The composition may be used in at least one of greenhouses, garden boxes and in the open ground. The plants resulting from application of the composition may be used for medical, scientific and economic purposes (e.g., cancer treatment, to treat oxidative stress, and inflammation, cosmetic preparations, premixes to animals, the manufacture of ropes and harnesses), and any other suitable purpose. The composition may increase the net productivity of plant photosynthesis, accelerate the germination of seeds and plants at the development stage, provide for rapid rooting and growth of the root system and reduce the degree of infection with bacteriosis and micromycetes (including but not limited to: bacteriosis of hemp, pink boll (and seed) rot of hemp; seed rot of hemp),

With this and other advantages and features that will become hereinafter apparent, a more complete understanding of the nature of the invention can be obtained by referring to the following detailed description and to the drawings appended hereto. The advantages of the invention will be realized and attained by the structure particularly pointed out in the written description and claims hereof.

It is to be understood that both the previous general description and the following detailed description are exemplary and explanatory and are intended to provide further explanation of the invention as claimed.

### BRIEF DESCRIPTION OF THE DRAWINGS

FIG. 1 is a block diagram of a process according to some embodiments.

FIG. 2A is a non-exhaustive prior art example of a fertilizer.

FIG. 2B is a non-exhaustive example of a composition according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known procedures and components have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, numerous implementation-specific decisions must be made to achieve the developer's specific goals, which may vary from one implementation to another. Moreover, it should be appreciated that such a development effort might be complex and time consuming, but would nevertheless be a routine undertaking of design, fabrication and manufacture for those of ordinary skill having the benefit of this disclosure.

One or more embodiments provide a composition to stimulate the growth of phytomass and provide stress resistance of plants during the growing season. The composition may accomplish this efficiently and with speed due to the good penetrating ability and high rate of absorption of substances by the plant due in part to the ultra-small size of the active substances of the composition.

Composition

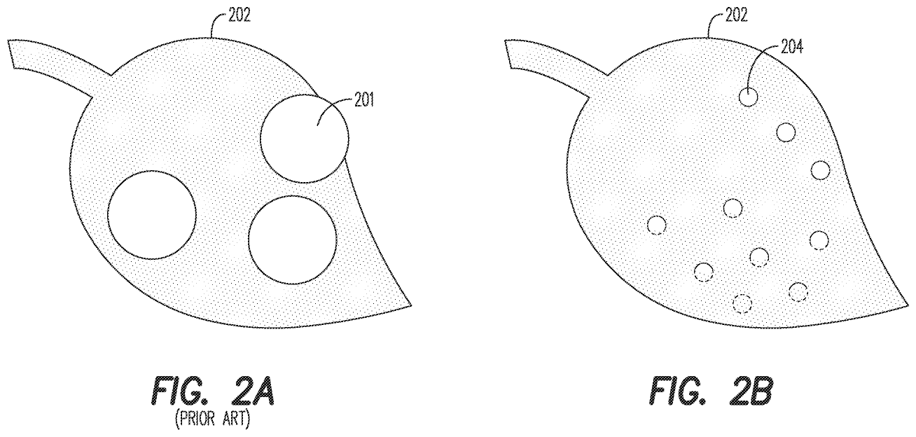

One or more embodiments provide a composition 100 for stimulating the growth of phytomass of a plant 202 (FIG. 2B) as well as for increasing plant resistance to stress factors. The fertilizer 100 contains a water-soluble composition comprising: a solvent/alcohol compound, at least one amino acid, such as methionine, Vitamin B; citrate and/or citric acid; sodium pyruvate and/or potassium pyruvate; potassium malate; ammonium malate liquid solution at least one trace element and at least one carboxylic acid. The pH of the composition 100 may be from about 5.0 to 11.5, and more particularly from 6.4 to 10.6. Vitamin B may be in the amount of 0.01% to 1.1% by volume of the total composition; citrate may be in an amount of 0.05% to 2.5% by volume of the total composition. The citrate may act as a regulator of acidity.

As used herein, the term “about” will be understood to broaden the ranges somewhat to include values that may be attributable to known errors in measurement, compounding the fertilizer composition, or expected variations in raw material compositions. In most cases, the term “about” modifies the value by +−10%.

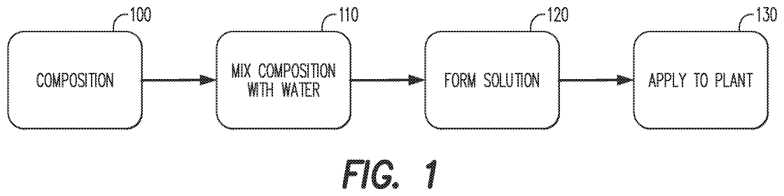

In one or more embodiments, and as described in FIG. 1, the composition 100 may be mixed with water 110 at a temperature of about 34° C. to about 20° C. to form a ready solution 120 for application 130 to the plant 202. In one or more embodiments, the composition 100 may be diluted with water in a proportion of about 1 part composition to 1000 parts of water. The diluted composition may be dispersed/applied to a plant 202 via different irrigation systems including but not limited to: localized irrigation, drip irrigation, sprinkler irrigation, center pivot irrigation and lateral move irrigation. In one or more embodiments, the composition 100 may be used outdoors and in all systems of greenhouses, including natural soil and all kinds of artificial soils and substrates, as well as in an aquatic environment of plant root culture.

In one or more embodiments, alcohol may be part of the composition 100 and may be used as a stabilizing and dispersing agent for dissolving (e.g. solvent) the composition 100 in water. The alcohol may be any of Propane-1,2,3-triol or Propane-1,2-diol, or any other suitable alcohol. The alcohol may be in an amount of about 0.1% to about 7.6% of the total composition. Propane-1,2,3-triol may be about 0.3% to 5.2% of the total volume of the composition. Propane-1,2-diol may be from about 0.2% to about 5.4%, and preferably about 0.7% to about 4.4% of the total composition. In addition, the solvent can be Propane-1,2,3-triol and Propane-1,2-diol in a range of about 0.35% to about 6.0% for both by volume of the total composition, preferably from about 0.35% to about 3.5% by volume of the total composition.

As described above, an existing problem in conventional crop/plant production is the low rate of absorption of substances by soil biota and plants, due to the large size of particles 201 contained in the conventional fertilizers. As used herein, “soil biota” may refer to the micro-organisms, soil animals and plants living all or part of their lives in or on the soil. To address this, the composition 100 provided by one or more embodiments includes ultra-small particles 204, which provide high speed of penetration into the organs of the plants 202. As a non-exhaustive example, the larger particles of the conventional fertilizer 201 may remain on the surface of the plant 202 without being absorbed, as shown in FIG. 2A. On the other hand, as shown in FIG. 2B, the ultra-small particles 204 of the composition 100 are readily and quickly absorbed by the plant 202 (e.g., the faded/patterned particles have already been absorbed by the plant). The ultra-small particles 204 may be the elements of nutrition for the plant 202 that make up the composition 100. The size of the largest ultra-small particles 204 may not exceed about 100 microns, in one or more embodiments. Other suitable sized particles may be used. It is noted that the presence of the solvent (dissolved fertilizer composition) promotes rapid transport in the soil system and the plant elements.

Nitrogen

Nitrogen is the most important element that affects the process of metabolism in the plant 202 and is part of organic substances such as proteins, nucleic acids, nucleoproteins, chlorophyll, alkaloids, phosphatides, etc. Nitrogen is represented in the composition 100 as Ammonium nitrate NH4NO3 and is from 0.2% to 1.4% of the total volume of the composition 100.

For cultivated plants, food availability is an important concern, as uneven distribution of nutrients and symbiotic bacteria in the rhizosphere of the soil or substrate in which the plant is planted, affect the productivity of the plant. Certain plants require certain chemicals and bacterial strains (e.g., the soil bacteria may convert various minerals into plant nutrients). The use of the composition 100 described herein, with application depending on the period of the plant growth and development and the status of soil fertility, may provide for maximum productivity of the plant.

In the practice of using fertilizers for growing plants of the Cannabaceae family, a large amount of nitrogen is used for active growth of the biomass. As used herein, the terms “biomass” and “phytomass” may be used interchangeably. The majority of plants obtain most or all of their nitrogen requirements from the soil. The nitrogen in the soil is found to occur primarily in three forms: organic nitrogen, ammonium nitrogen and nitrate nitrogen, of which ammonium nitrogen and nitrate nitrogen are the primary forms utilized by plants. This nitrogen is absorbed by plants in solution from the soil in the form of ammonium ions and nitrate ions. The concentration of cations and anions that accompany the nitrogen (e.g., ammonium ions and nitrate ions) may have a great influence on the absorption of ammonia or nitrate nitrogen by plants. For example, with ammonia nutrition, the positive effect of increasing the concentration of calcium, magnesium and potassium in the nutrient substrate (fertilizer) is enhanced. The composition 100 may, in some embodiments, include dipotassium 2-hydroxybutanedioate C4H4K2O5 and Ammonium Hydroxybutanedioate CH₁₂N₂O₅ in an amount of about 0.1% to about 3.5% by volume of the total composition, but preferably from about 0.2% to about 1.8%. The composition 100 may include a ratio of 1-2 parts dipotassium 2-hydroxybutanedioate C₄H₄K₂O₅ and 2-4 parts Ammonium Hydroxybutanedioate CH₁₂N₂O₅, but preferably a ratio of one part dipotassium 2-hydroxybutanedioate C₄H₄K₂O₅ and three parts Ammonium Hydroxybutanedioate CH₁₂N₂O₅.

Malate

Malate is another substance central to plant metabolism. Its importance in plant mineral nutrition is reflected in its role in symbiotic nitrogen fixation, phosphorus production, and resistance to aluminum. In nitrogen-fixing root nodules, malate is the main substrate for respiration of bacteria, thus feeding nitrogenase. Malate also provides carbon skeletons for the assimilation of fixed nitrogen into amino acids. As described above, malate may be included in the composition 100 in an amount of about 0.1% to about 3.5% by volume of the total composition.

Potassium

The substances used in the composition 100 include important elements such as potassium. Potassium is an important nutrient and has a great influence on a number of biochemical and physiological processes related to plant growth, metabolism, anatomy and morphology. Potassium also directly affects the plants ability to survive biotic and abiotic stresses such as disease, pests, drought, salinization, cold and frost, and waterlogging.

B Vitamin

The role of B vitamins in plant nutrition is to regulate the redox reactions of enzyme formation, as well as the exchange of lipids and carbohydrates in living cells. All B vitamins are coenzymes, improve tissue adaptation and growth, and are used to stimulate biochemical reactions in the cell.

Thiamine (B1) is a coenzyme of the Krebs cycle, and its introduction increases the growth and differentiation of plants. In the composition 100, thiamine stimulates the development of strong roots that can absorb more nutrients.

The presence of nicotinic acid in the composition 100 has a stimulating effect on the development of plants, as it is a precursor to the synthesis of metabolites associated with the synthesis of indolyl acetic acid. The use of these vitamins allows the plant to overcome critical moments and stressful effects in the process of plant growth. As described above, the composition 100 may include vitamin B1 (or as thiamine hydrochloride C12H17C1N4OS), vitamin B6 (or as pyridoxine C8H11NO3) and nicotinic acid (or as vitamin B3, PP, C6H5NO2) mixed in the proportion of one part vitamin B1, to five parts vitamin B6, to five parts nicotinic acid in an amount of about 0.01% to about 1.1% by volume of the total composition.

Metals

The shortage of available metals is a limiting factor for the full growth of plants. For example, in soils, iron is present in large quantities, but its availability to plants is usually very low, which is why iron deficiency is a common problem. While conventional fertilizers include metal elements, they may not be easily assimilated by plant and soil microorganisms due to their structure. One or more embodiments address this by introducing ligands into the composition 100, as the ligands have a chelate structure, which makes them easier to digest. As a non-exhaustive example, iron citrate used in the composition 100 may be easily available for absorption by the plant. The citrate may also act as a regulator of acidity for the composition 100. As described above, the citrate may be in an amount of about 0.05% to about 2.5% by volume of the total composition. In some embodiments, the composition 100 may include iron citrate in an amount of about 0.1% to about 1.5% by volume of the total composition.

Carboxylic Acid

Citric acid, along with succinic and grape acids, is a key link in the tricarboxylic acid cycle. The tricarboxylic acid cycle is: responsible for the respiration stage of all cells that use oxygen; the center of intersection of many metabolic pathways in the body; and used in the intermediate stage between glycolysis and the electron transport chain. In addition to a significant energy role, the tricarboxylic acid cycle is also assigned a significant plastic function, that is, it is an important source of precursor molecules, from which such important compounds for the cell's vital activity as amino acids, carbohydrates, fatty acids, etc. are synthesized during other biochemical transformations. In some embodiments, the composition 100 may include 2-Hydroxypropane-1,2,3-tricarboxylic acid C₆H₈O₇, in an amount of about 0.5% to about 2.5% of the total composition. In some embodiments, a ratio of iron (3+) 2-hydroxypropane-1,2,3-tricarboxylate C₆H₅FeO₇ to 2-Hydroxypropane-1,2,3-tricarboxylic acid C₆H₈O₇ is one part iron (3+) 2-hydroxypropane-1,2,3-tricarboxylate C₆H₅FeO₇ to four parts 2-Hydroxypropane-1,2,3-tricarboxylic acid C₆H₈O₇, and is from about 0.6% to about 2.2% of the total composition.

In some embodiments, the carboxylic acid may include Ethanedioic acid C₂H₂O₄ and 2-Hydroxybutanedioic acid C₄H₆O₅, in an amount of about 0.05% to about 2.5% of the total composition. The Ethanedioic acid C₂H₂O₄ and 2-Hydroxybutanedioic acid C₄H₆O₅ may also act as acidity regulators. In some embodiments, the ratio of Ethanedioic acid C₂H₂O₄ and 2-Hydroxybutanedioic acid C₄H₆O₅ may be three parts Ethanedioic acid C₂H₂O₄ to one part 2-Hydroxybutanedioic acid C₄H₆O₅.

In some embodiments, the carboxylic acid may include Pyridine-3-carboxylic acid C₆H₅NO₂ in an amount of about 0.01% to about 1.1% of the total composition, and preferably a range of about 0.1% to about 0.4%.

Amino Acids

Amino acids are the main ingredients in the process of protein synthesis. Amino acids may directly or indirectly affect the physiological activity of the plant 202. Amino acids may be delivered to the plant 202 through an aqueous or other solution through watering the root area of the soil. This may help in improving the soil microflora, thereby facilitating the absorption of nutrients. Foliar nutrition in the form of protein hydrolysate (known as liquid amino acids) and leaf spray may provide ready-made building blocks for protein synthesis. Amino acids may be included in the composition 100 due to their participation in various metabolic processes in plants of the Cannabaceae family. In some embodiments, the amino acids in the composition 100 may refer to at least one of D-isomers, L-isomers and DL-isomers.

In some embodiments, the amino acids in the composition 100 may be 2-Aminopentanedioic acid C₅H₉O₄N, and 2-Aminobutanedioic acid C₄H₇NO₄, in a total amount of about 0.2% to about 4.6% by volume of the total composition. The ratio of 2-Aminopentanedioic acid C₅H₉O₄N to 2-Aminobutanedioic acid C₄H₇NO₄ may be four parts 2-Aminopentanedioic acid C₅H₉O₄N to one part 2-Aminobutanedioic acid C₄H₇NO₄, and preferably in a ratio of 3.7:1.

In some embodiments, the amino acids in the composition 100 may be 2-Aminopropanoic acid C₃H₇NO₂ and 2-Amino-3-methylbutanoic acid C₅H₁₁NO₂, in a total amount of about 0.02% to about 4.6% by volume of the total composition. The ratio of acids 2-Aminopropanoic acid C₃H₇NO₂ to 2-Amino-3-methylbutanoic acid C₅H₁₁NO₂ may be two parts 2-Aminopropanoic acid C₃H₇NO₂ to one part 2-Amino-3-methylbutanoic acid C₅H₁₁NO₂.

In some embodiments, the amino acid in the composition 100 may be 2-amino-4-(methylthio) butanoic acid in a total amount of about 0.1% to about 3.5% of the total volume of the composition.

In some embodiments, the composition 100 may include sodium pyruvate, such as α-Ketopropionic acid sodium salt C₃H₃NaO₃ and/or a potassium pyruvate, such as potassium 2-oxopropanoate C₃H₃KO₃ in an amount of about 0.2% to about 2.8% by volume of the total composition. The ratio of α-Ketopropionic acid sodium salt C₃H₃NaO₃ to potassium 2-oxopropanoate C₃H₃KO₃ may be one part α-Ketopropionic acid sodium salt C₃H₃NaO₃ to three parts potassium 2-oxopropanoate C₃H₃KO₃.

Humic Acid

In some embodiments, the composition 100 may also include humic acid, which may perform an important set of biospheric functions, including but not limited to, soil structuring, accumulation of micronutrients, and regulation of geochemical processes of metal derivatives in water and soil ecosystems. Several different types of oxygen-, nitrogen-, and gray-containing groups may be found in humic acid, including, but not limited to, carboxyl, phenolic, alcohol hydroxyl, carbonyl, quinone, methoxyl, ester, amino groups, amidogroups, imidogroups.

In some embodiments, the humic acid may be obtained by alkaline hydrolysis from leonardite or brown coal. Moreover, the alkaline reagent may be potassium and sodium in the proportions of three parts of potassium to one part of sodium. In some embodiments, the amount of humic acid in the composition 100 may be about 0.1% to about 5% of the total volume of the composition.

In some embodiments, the humic acid may be included in the composition 100 in a liquid solution, where the humic acid has a size from about 50 nanometers to about 50 microns in size, but preferably from about 100 nanometers to about 20 microns. Other suitable sizes may be used.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A composition for stimulating the growth of phytomass and plant resistance to stress factors, containing a water-soluble composition comprising:
at least one amino acids;
solvent compound;
vitamin b in the amount of 0.01% to 1.1% by volume of the total composition;
citrate, in an amount from 0.05% to 2.5% by volume of the total composition;
pyruvate in an amount from 0.2% to 2.8% by volume of the total composition;
malate in an amount from 0.1% to 3.5% by volume of the total composition;
at least one trace element; and
at least one carboxylic acid;
wherein the composition is water-soluble and wherein the pH of the composition is from 5.0 to 10.3.

2. The composition according to claim 1, wherein the solvent compound is an alcohol compound and any of Propane-1,2,3-triol or Propane-1,2-diol, and wherein the alcohol compound is a stabilizing and dispersing agent operative to dissolve the composition in water, from 0.1% to about 7.6% of the total composition.

3. The composition according to claim 1, wherein the citrate is iron citrate and is an amount from 0.1% to 1.5% of the total volume of the composition.

4. The composition according to claim 1, wherein the at least one carboxylic acid is 2-Hydroxypropane-1,2,3-tricarboxylic acid C₆H₈O₇, in the amount of 0.5% to 2.5% by volume of the total composition.

5. The composition according to claim 1 in which the at least one carboxylic acid is iron (3+) 2-hydroxypropane-1,2,3-tricarboxylate C₆H₅FeO₇ and 2-Hydroxypropane-1,2,3-tricarboxylic acid C₆H₈O₇ in a ratio of one part iron (3+) 2-hydroxypropane-1,2,3-tricarboxylate C₆H₅FeO₇ to four parts 2-Hydroxypropane-1,2,3-tricarboxylic acid C₆H₈O₇, and the total amount of both carboxylic acids together is from 0.6% to 2.2% of the total composition.

6. The composition according to claim 1, wherein the at least one carboxylic acid is Ethanedioic acid C₂H₂O₄ and 2-Hydroxybutanedioic acid C₄H₆O₅, and the total amount of both carboxylic acids together is from 0.05% to 2.5% of the total volume of the composition.

7. The composition according to claim 1, wherein the at least one carboxylic acid includes 2-Hydroxybutanedioic acid C₄H₆O₅ and Ethanedioic acid C₂H₂O₄ in a ratio of 1 part 2-Hydroxybutanedioic acid C₄H₆O₅ to three parts Ethanedioic acid C₂H₂O₄.

8. The composition according to claim 1, wherein the at least one carboxylic acid is Pyridine-3-carboxylic acid C₆H₅NO₂ in the amount of 0.01% to 1.1% of the total composition.

9. The composition according to claim 1, wherein the at least one amino acid is 2-Aminopentanedioic acid C₅H₉O₄N, and 2-Aminobutanedioic acid C₄H₇NO₄, in an amount of 0.2% to 4.6% by volume of the total composition.

10. The composition according to claim 1, wherein the at least one amino acid is 2-Aminopentanedioic acid C₅H₉O₄N and 2-Aminobutanedioic acid C₄H₇NO₄ in a ratio of four parts 2-Aminopentanedioic acid C₅H₉O₄N to 1 part 2-Aminobutanedioic acid C₄H₇NO₄.

11. The composition according to claim 1, wherein the at least one amino acid is 2-Aminopentanedioic acid C₅H₉O₄N and 2-Aminobutanedioic acid C₄H₇NO₄ in a ratio of 3.7 parts 2-Aminopentanedioic acid C₅H₉O₄N to 1 part 2-Aminobutanedioic acid C₄H₇NO₄.

12. The composition according to claim 1, wherein the at least one amino acid is 2-Aminopropanoic acid C₃H₇NO₂, and 2-Amino-3-methylbutanoic acid C₅H₁₁NO₂, in an amount from 0.02% to 4.6% by volume of the entire composition.

13. The composition according to claim 1, wherein the at least one amino acid is 2-Aminopropanoic acid C₃H₇NO₂ and 2-Amino-3-methylbutanoic acid C₅H₁₁NO₂ in a ratio of two parts 2-Aminopropanoic acid C₃H₇NO₂ and one part 2-Amino-3-methylbutanoic acid C₅H₁₁NO₂.

14. The composition according to claim 1, wherein the at least one amino acid is 2-amino-4-(methylthio) butanoic acid in an amount of 0.1% to 3.5% of the total volume of the composition.

15. The composition according to claim 1 in which the at least one amino acid, is at least one of D-isomers, L-isomers, and DL-isomers.

16. The composition according to claim 1, wherein the pyruvate is α-Ketopropionic acid sodium salt C₃H₃NaO₃ and potassium 2-oxopropanoate C₃H₃KO₃ in an amount of 0.2% to 2.8% by volume of the total composition.

17. The composition according to claim 16 wherein the ratio of pyruvates is one part of α-Ketopropionic acid sodium salt C₃H₃NaO₃ to three parts of potassium 2-oxopropanoate C₃H₃KO₃.

18. The composition according to claim 1, further comprising:
humic acid in an amount of 0.1% to 5% by volume of the total composition, wherein the humic acid is obtained by alkaline hydrolysis from leonardite, or brown coal.

19. The composition according to claim 18, wherein the humic acid is in a liquid solution, and the humic acid has a size from 100 nanometers to 20 microns.

20. The composition according to claim 1, wherein the composition is mixed with water at a temperature of 34° C. to 20° C. degrees Celsius.

21. The composition according to claim 1, wherein the composition is diluted with water in a proportion of about one part composition to 1000 parts of water.

22. The composition of claim 1, wherein the composition is received by at least one of:
at least one irrigation system, wherein the irrigation system is at least one of: a localized irrigation system, a drip irrigation system, a sprinkler irrigation system, a center pivot irrigation system, and a lateral move irrigation system;
a plant;
a natural soil;
an artificial soil; and
a soil substrate.

23. The composition according to claim 1, wherein the pH of the composition is from 8.4 to 10.3.
